(19) United States
(12) Patent Application Publication
(10) Pub. No.: US 2007/0220090 A1
(43) Pub. Date: Sep. 20, 2007

(54) SYSTEM AND METHOD FOR ONLINE GROUP NETWORKS

(76) Inventor: Rohan Roy Hall, Sparks, NV (US)

Correspondence Address: ROHAN HALL, 1344 DISC DRIVE, # 105, SPARKS, NV, 89436, US

(21) Appl. No.: 11/306,892

(22) Filed: Jan. 14, 2006

(51) Int. Cl. G06F 15/16; H04L 12/16; H04Q 11/00

(52) U.S. Cl. 709/204; 370/260

(57) ABSTRACT

A method and system is described for providing groups, organizations, associations and their chapters (groups) the ability to recruit members online, network and communicate with group members online, network and communicate with other groups online. A membership group is allowed to create a group online. This group is able to use technology to recruit other group members and to collect membership fees, convention and event fees, and donations via credit card and other online payment methods. A group is allowed to “link” with other groups. Members are able to create profiles and search the profile of members of their group as well as members of linked group. Members are given various online communication tools such as email, IM, Chat, Blog, and Forums to network and communicate with each other.

### FIELD OF THE INVENTION

The present invention relates to online social and business networking of groups and more particularly, this invention relates to a method and system of online recruitment, networking, communications and management of membership groups, organizations and associations.

### BACKGROUND OF THE INVENTION

There are tens of thousands of membership groups, associations and organizations within the United States and throughout the world. The chapters of many of these organizations are dispersed throughout the world. The Lions club for instance currently has approximately 46,000 chapters consisting of approximately 1.4 million users in 196 countries. The Red Cross, the Salvation Army, the NAACP, the Democratic National party, the AFL-CIO, the Black Chamber of Commerce are other examples of large organizations with chapters geographically dispersed nationally or internationally. In addition to large organizations there are local and regional membership organizations focused on issues relating to their community or to the world.

Throughout this document we will refer to these organization and their chapters, regardless of their size, as “groups”. These groups typically will have a membership structure. Their focus may include networking, politics, business, technology, research, environment, legal and a multitude of other areas.

Groups typically have meetings at a physical location once or more per month. They rarely have the opportunity to meet and communicate with other group members except during group meetings. Additionally, they rarely have the opportunity to interact with other group members in different cities, states and countries except during regional, national or international conferences annually, bi-annually or quarterly.

The restricted nature of groups' members to interact and communicate with each other minimizes the value of the group to the group's membership. Because members only see each other at monthly meetings and yearly conferences they miss a lot of potential networking, business, and social opportunities. A member, for instance, of the local Chamber of Commerce may want to hire someone or present a business opportunity to others but would have to wait until the next monthly meeting. On a larger scale such as disaster assistance, the Red Cross may want to utilize their membership in the region of a disaster but have limited capacity to communicate with and direct those members. This recently happened with the Hurricane Katrina and the Asian Tsunami disaster.

On a political scale, political parties such as the democratic and republican parties in the United States have a need to activate a “grass roots” campaign. Their primary problem is to understand how to do this efficiently and immediately with technology. Experimentation with blogs during the 2004 campaign showed some promise but was very limited.

Recruitment—Currently, many membership organizations recruit manually. This process is done by a member physically meeting a non-member and inviting him/her to a membership meeting where the intention is to recruit the individual towards becoming a new member. This very inefficient process has caused many organizations to have a negative net membership over the last decade.

Communications—In the recent Hurricane Katrina in the United States gulf coast many of these organizations were ready and willing to give aid to those who need it but did not have the communication infrastructure to provide such services. The membership wanted to serve their community but did not have the communication infrastructure to collaborate with other group within their organization or with other organizations to be very effective. This was a problem shared by governmental institutions as well. The high technology utilized by some groups currently a website and the emailing of an electronic newsletter. The problem with this method of communication is that it is one-directional, meaning that members are not able to respond to such communication or to interact with other members regarding such communications. One-directional communication does not allow further discussion, collaboration, and interaction about the subject matter of the original communication.

Networking—One of the primary reasons members join membership organization is the ability to network socially and in business. However, because of the lack of an easy way to facilitate networking, members often participate less in these organizations or the eventually leave.

Membership Management—Because members are typically geographically dispersed this causes an ongoing management issue and create retention and participation issue. There needs to be a better way for the management of the entire organizational structure as well as the management of individual chapters.

Financial—Because of the lack of funding or technical expertise many of these organizations still take weeks to process membership payments, donations, convention fees and other financial transactions. Typically these organizations collect checks only and do not have the ability to collect credit cards online or any other form of online payment. This causes financial transactional errors and creates liabilities and potential auditing failures for these groups.

Collaboration with other related groups—These organizations may benefit from working with other related organizations. For instance, the Lions Club who focuses on helping the blind may be able to collaborate on research and other projects with groups like the National Federation of the Blind. Another example is the Black Chamber of Commerce working with the Black MBA—two groups with the common mission of empowering black businesses and professionals.

The present invention would resolve the above-described issues that are faced by groups, associations and organizations. A group network and communications application would allow membership type organizations to grow, communicate better, provide better networking capabilities and run more efficiently. Organizations would have a safe and private environment online to recruit, network, communicate and grow. This invention will provide benefits far beyond what are currently available to membership organizations on the market today.

The present invention will specify a technology and process to help groups improve their current methods of recruitment, communication, and networking. Additionally, the invention gives groups the ability to better communicate with other groups and the ability to process payments for membership fees, donations, and convention fees online.

### SUMMARY OF THE INVENTION

The present invention provides a method for online group recruitment, networking, communications and payment processing. It allows groups to create a presence online and to invite their membership to an online networking environment. Once online, groups are able to communicate with other members of that group online in a private and secure environment. The nature of a group community implies trusted relationships. Group members are therefore able to create profiles, search the personal and business profile of other members of that group, and communicate with other group members via a variety of methods including: email, Instant Messenger (IM), Chat, Forums, Blogs, Voice Over IP (VoIP) and other online communications methods including but not limited to the methods listed above.

Group members are able to invite and recruit their friends, families, and associates to become a member of the group. Newly invited group members require the approval of the group admin (a member of that group that serves as a moderator, possibly an executive of the group). Once membership is approved, the new group member gets full access to network and communicate with the group.

Groups that have a common interest are able to link with each other. Therefore, related or unrelated groups like the Lions Club and the Black Chamber of Commerce are able to link online, where their membership can network and collaborate on projects of mutual interest. Linked groups can unlink when there is no further need for this shared communications.

Groups can also bill and collect group membership fees via credit card and other online payment methods. Groups can also collect funds for donations, conventions or other fund raising events.

### BRIEF DESCRIPTION OF DRAWINGS

For a fuller understanding and more complete appreciation of the nature and advantages of the present invention, as well as the preferred mode of use, reference should be made to the following detailed description read in conjunction with the accompanying drawings.

FIG. 1a is a graphical depiction of the way groups currently recruits members on a one to one basis.

FIG. 1b is a graphical depiction that illustrates the recruitment hierarchy of this invention where the site admin recruits group admin, group admin recruits group members, group members recruit other group members.

FIG. 1c is a graphical depiction of members of a specific group recruiting other group members electronically with this invention

FIG. 2 is a technical server architecture diagram of an embodiment of the present invention

FIG. 3 is a graphical depiction of how groups currently communicate electronically with their membership

FIG. 4 is a graphical illustration where members within a group utilizing an embodiment of the present invention communicate with each other online

FIG. 5 is a graphical depiction of a member belonging to and networking with multiple groups including groups that are linked

FIG. 6 is a graphical depiction of multiple linked groups within the same organization networking and communicating electronically with each other

FIG. 7 is a graphical depiction of multiple linked groups, geographically dispersed, within multiple organizations networking and communicating with each other electronically

### DETAILED DESCRIPTION OF PREFERRED EMBODIMENTS

The following description is the best embodiment presently contemplated for carrying out the present invention. This description is made for the purpose of illustrating the general principles of the present invention and is not meant to limit the inventive concepts claimed herein.

The present invention allows membership groups, organizations and associations of all types (herein referred to as groups) to network and communicate online where the members of a group are linked together based on a trusted group relationship and where groups are able to link to and communicate with other groups with a common interest. The network allows groups to invite members to join them online, to communicate online, to network online with other group members and with members of other groups. This networking and communication includes where the member shares membership in a common group, where the member allows other non-member access to their profile, or where the other group is “linked” to the group that the member belongs to. Members are allowed to join multiple groups. Group Admins are able to request and execute the linkage of their group to one or more other groups.

The network allows group members to search the profile of other members of the group they belong to. An implied trust exists between members of a group. Members are able to search on personal as well as business profile information about other members of that group in addition to members of a linked group. Members are allowed to limit the search and contact options that others members have regarding their profile. For instance, a member can “block” attempted contacts from other members of the group. Additionally, members that are not a part of a specific group cannot search profiles, view the profiles, or contact members of that specific group that they do not belong to.

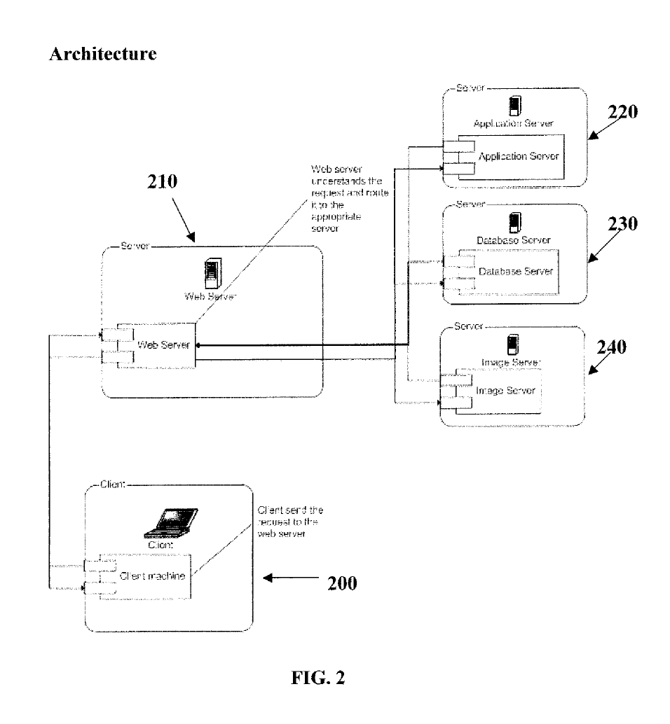

FIG. 2 is a technical architecture diagram of an embodiment of the present invention. A user interacts with the system by using a client device 200, which is connected to a web server 210 via the Internet. The web server interprets the client request and route the request to the appropriate server which could include, but not be limited to, Application Servers 220, Database Servers 230, Image Servers 240. These servers may reside on the same physical machine or they may be distributed to multiple machines. The servers manage the application logic, databases, images and files used by the application.

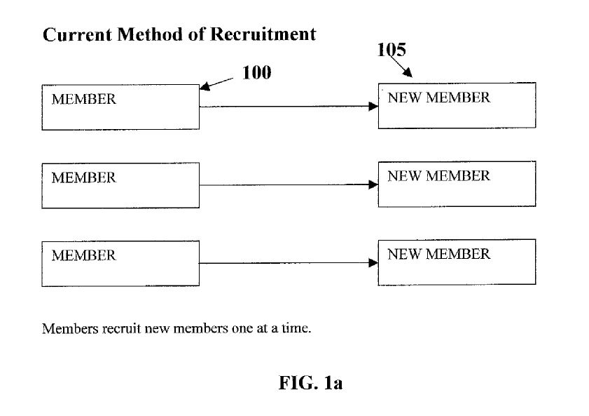

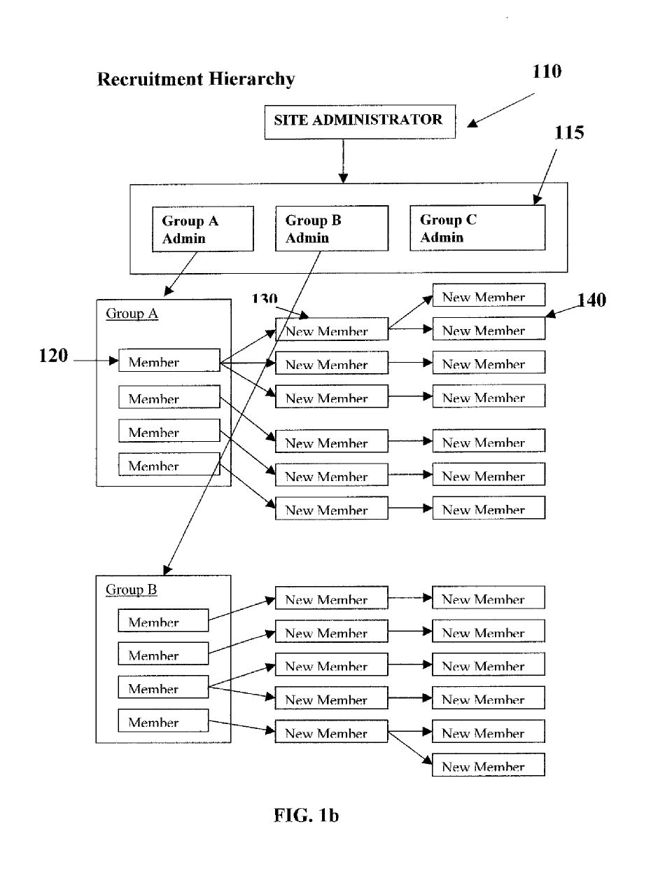

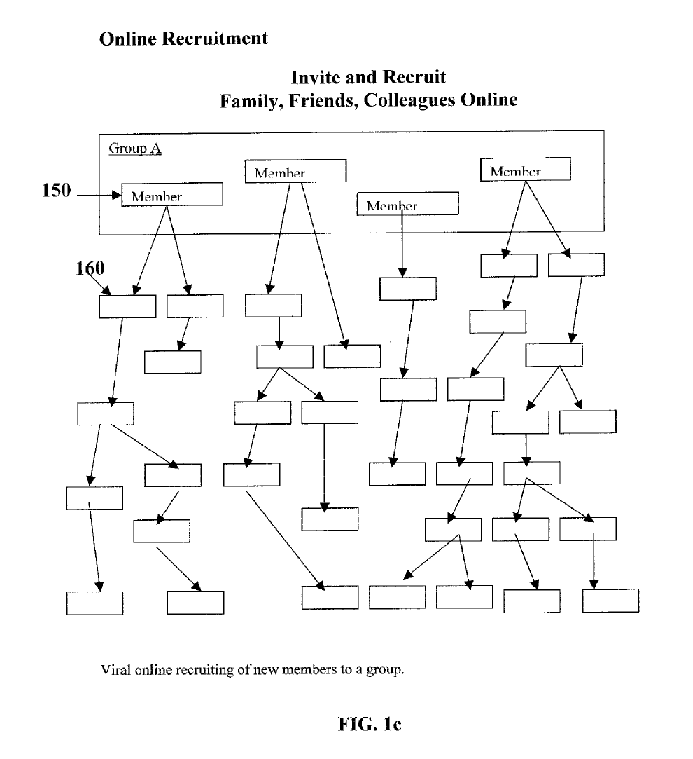

FIG. 1a illustrates the current method of recruitment for many groups. In this illustration a members 100 meets and invites another member 105 to a membership meeting or to join the group. This is a manual and ineffective process employed by many groups today especially since many invited members never attend meeting because they are too busy, they forget or they simply loose interest.

FIG. 1b is an embodiment of the present invention. It illustrates the hierarchy of recruitment employed by the invention where the site admin recruits the group admins, the group admins recruit their membership, and the membership recruits friend, family, associates and others to join their group. In this embodiment the Site Administrator 110 is the “super user” of the system. This individual(s) has ultimate access to the entire site and invites or approve the membership of group administrators 115 to the system. The group administrators are allowed to start new groups and to invite existing or new members 120 to the group online. Members are then allowed to invite others to become new members 130 of this group. New members are allowed to invite others to become new members 140 of this group. The group admin would have the ability to automatically or manually approve the membership of each member of his/her group.

FIG. 1c is an embodiment of the present invention where members of a group 150 invite their friends, family, colleagues, associates and others 160 to join their group online. Those who are invited and who become new members invited others to join the group. This process is repeated by new members to create an exponential “viral” type of membership growth for a group.

Users can become a member of one or more groups. Each group would post the criteria for membership of their group. Users can search the site online to see the different groups that are available on the site. Users can be approved to be a guest member or a group member of groups or their membership request could be rejected by the group admin. A guest member in this embodiment would have limited access to the group's information. Group members have full access to the group's information. Members would be required to create a membership profile. Profiles would include various pieces of information including social likes and dislikes, business and professional experience, user photos and videos. This is not a full description of the various items of a user profile or the scope of a user membership. It is intended to give an understanding of this function.

Members of a group in this embodiment are allowed to search the profile of other members for business or social reasons. For instance, a member may search the profile of other members to find a friend to play golf or to find a member with certain business expertise. The member would then be allowed to view the found member's profile and contact him/her online via various allowed communication methods including email, Instant Messenger (IM), Chat, Forum, Voice over IP and other online communication methods.

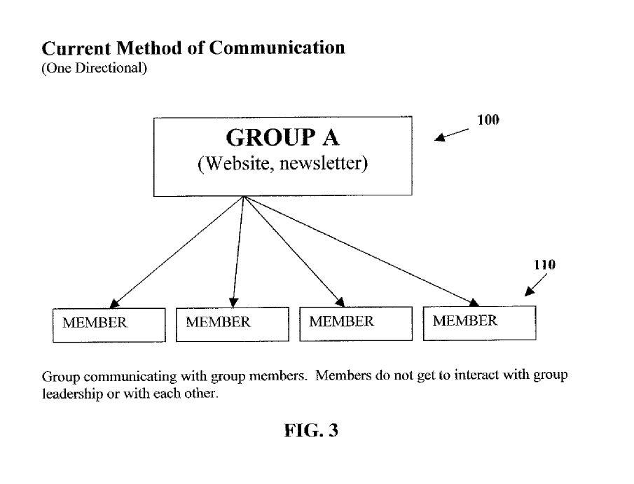

FIG. 3 illustrates the current method of electronic communication employed by many groups. This method is primarily a one-directional communication method via a website or a newsletter. Members are not able to respond or interact to the group leadership or to each other via this type of communication method. It is better than being limited to physical monthly meetings but does not allow interactivity between a group's membership.

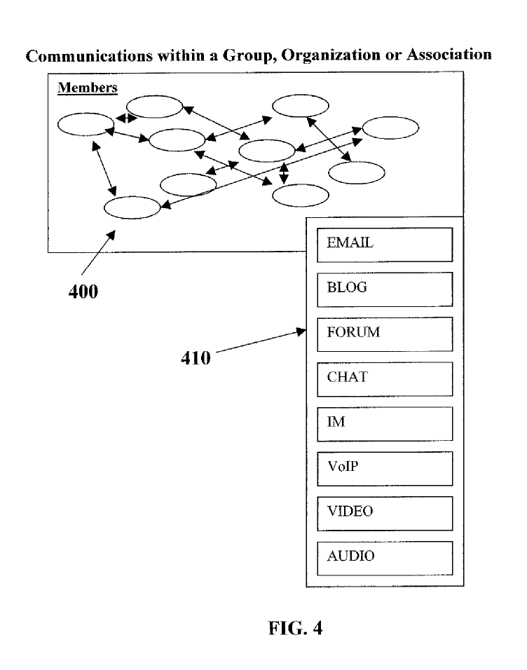

FIG. 4 illustrates the embodiment of the present invention where members of a group 400 are allowed to communicate via various Internet based communications methods 410. These methods include, but are not limited to, email, blog, forum, Instant Messenger (IM), Chat, Voice over IP (VoIP), Video files, Audio files, other files types such as MS Word documents, PDF, MS Excel, Powerpoint, GIF etc. The communication is private and secure between members of that group. The members are able to communicate equally to the different members of the group and to the group leadership. Users of the site that are not members of this group are not able to interact with the members of this group unless: (a) they interact in another group where they are both members; (b) the member setting allows the search and communication with others outside the group; (c) the group is linked to another group where the linked groups allow access to the membership of each group.

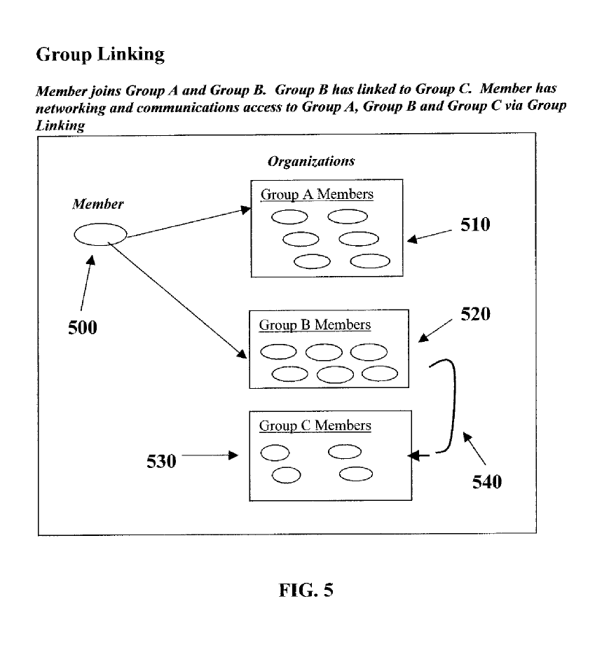

FIG. 5 is the embodiment of the present invention. In this illustration a member 500 has joined two groups, Group A 510 and Group B 520. The member is able to network and communicate with Group A and Group B as a member of those groups. This embodiment also illustrates the linking of Group B 520 with Group C 530. This linking 540 now gives the member 500 the ability to network and communicate with Group C even though he is not a member of Group C. The member therefore now has access to Group A, Group B and Group C even though he is only a member of Group A and Group B. The embodiment of this invention would allow Group Administrators the ability to request, from other Group Administration, the linking of groups and to execute the linking of such groups giving the group members communication and networking access to the members of the linked groups.

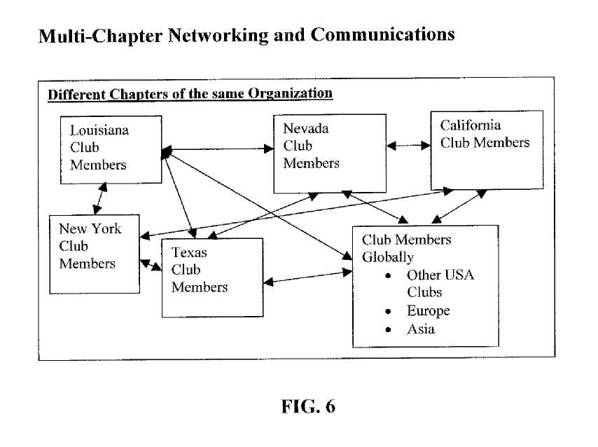

FIG. 6 illustrates an embodiment where a multi-national organization has multiple chapters in multiple cities, states and countries. In this embodiment, the various chapters have formed separate groups and the groups have active members online. The various groups have linked with each other. These linked groups are now able to network and communicate with each other online even though they belong to different groups or chapters. The Group Admins for each group would retain administrative control over their membership, however, the membership would be able to exchange, network and communicate with each other since they now belong to the same group network.

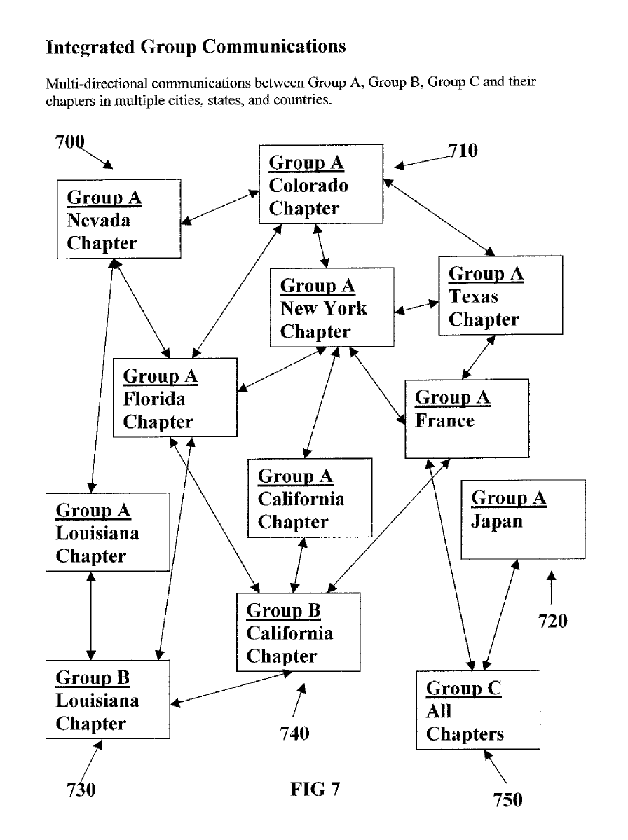

FIG. 7 illustrates a preferred embodiment of this present invention where multiple groups with multiple chapters throughout the world have joined the site. These groups have a common purpose and have decided to link with each other. The various chapters from Group A 700, 710, 720 have linked with the various chapters from Group B 730, 740 and have also linked with the various chapters from Group C 750. The chapters all now belong to the same group network and are able to take advantage of the networking and communications benefits of belonging to this network. In this embodiment, the linked groups can unlink if they so choose.

This preferred embodiment would include the ability to collect funds online on behalf of each group. The process of collecting funds for most membership organizations is very tedious and costly and is typically limited to payment via check or money order. Additionally, the process to establish an online payment processing system for groups can be very complicated and expensive. This embodiment resolves this issue by providing a payment processing system where the group would be able to collect membership fees, donations, fees for convention and events and other fees via credit card, debit card and other online payment options such as Paypal, echecks etc. The payment system would include recurring billing functionality as well as one-time payment functionality. The site would act as a third party payment processor and collect funds on behalf of the group. The funds would then be transferred to the group's bank account. This eliminates the need for each group to establish a merchant account and related technologies to accept credit card and other forms of online payments. The site may charge a fee for this service in addition to the normal bank processing fees.

The preferred embodiment would include reporting and management tools. Some reporting would include: membership listings, membership fee payment, donations received, past due membership, new members list. Management tools would allow the Group Admin to accept new members, block or delete members, broadcast communicate with members, link with other groups, unlink with linked groups. These functions are listed to illustrate some capabilities but should not be thought of as reporting and management functions in its totality.

The present invention may be embodied in other specific forms and embodiments without departing from the spirit or essential characteristics thereof. The exemplary embodiments shown in the present specification are, therefore, to be considered in all respects illustrative and not restrictive, of the scope of the present disclosure, and all changes which come within the meaning and range of equivalence of the exemplary embodiments are therefore intended to be embraced within the present disclosure.

What is claimed is:

1. A method of creating and maintaining a membership group network and communication system using a computer system, said method comprising:
inviting group administrators of membership organizations to join the site and allowing them the ability to start online groups and to invite their group membership
storing personal, social and business profiles of group members and allow them to join one or more groups
allowing group members to invite others to join their group and linking said members to their respective groups
allowing group members to search on the profiles of other members of their group
allowing group members to communicate with other group members via a variety of online communications methods
allowing groups to link with other groups to allow networking and communications between linked groups.

2. A method as recited in claim 1, wherein said method further provides the ability of group administrators to configure the look and feel of the group they have created.

3. A method as recited in claim 1, wherein said method further provides the ability of group administrators to upload email addresses and contact information of group members to the site from a comma separated values (csv) file, a spreadsheet, a flat ascii file, a database or other file storage system.

4. A method as recited in claim 1, wherein said method further provides the ability of group administrators to invite individuals to join the group via email.

5. A method as recited in claim 1, wherein said method further allows individuals to create profiles on the site.

6. A method as recited in claim 5, wherein said profile information including visible and invisible data including photos, videos, personal information, information about social interest, information about business and job experience.

7. A method as recited in claim 1, wherein said method further allows individuals to request membership of one or more groups.

8. A method as recited in claim 7, wherein said method further includes the ability of group administrators to accept or reject membership request.

9. A method as recited in claim 1, wherein said method further comprise a method of linking groups, said method comprising:
Group administrators submitting request to other group administrators to link their respective groups;
Group administrator receiving group linking request;
Group administrator accepting or rejecting group linking request.

10. A method as recited in claim 9, wherein said method further comprises allowing members to search the profile of members of groups they are linked to.

11. A method as recited in claim 9, wherein said method further comprise allowing members to communicate online via email, instant messenger, chat, discuss forum and other online communication methods to members of groups they are linked to.

12. A method as recited in claim 1, wherein said method further comprise allowing members to communicate online via email, instant messenger, chat, discuss forum and other online communication methods to members the groups they belong to.

13. A method as recited in claim 1, wherein said method comprise allowing members to search the profile of other members whereas these other members share membership in at least one group or whereas said member allows the unrestricted search of his/her profile by other members not belonging to a common group.

14. A method as recited in claim 13, wherein said method allows members to view the photos and detailed profile of other members.

15. A method as recited in claim 13, allowing members to leave comments and endorsements about another member.

16. A method as recited in claim 1, wherein said method allows the function to manually or automatically approve membership requests to a group, said method comprising:
Group Admin receives request from individual to become a member of said group
Group Admin manually reviews request and approves or denies request
Group Admin may also set option to automatically approve or deny all requests for membership to said group.

17. A method as recited in claim 1, wherein said method allows each group to have an individual home page that can be personalized by said group.

18. A method as recited in claim 17, wherein said home page can be accessed online without the need to log into the site.

19. A method as recited in claim 17, wherein said home page would exhibit specific information about the group.

20. A method as recited in claim 1, wherein said method further comprise a method to allow groups to accept payments and donations online, said method comprising:
Members paying membership via credit card, debit card and other online method;
Members and non-members making donations online via credit card, debit card and other online payment methods;
Members and non-members paying convention and event fees online via credit card, debit card or other online payment methods.

21. A method as recited in claim 20, wherein said method further comprises the collection of such funds on behalf of the group.

22. A method as recited in claim 20, wherein said method further comprises the payment of such funds to the group via electronic transfer or via check.

23. A method as recited in claim 20, wherein said method does not require the group to establish a merchant account.

24. A method as recited in claim 20, wherein said method comprises a tool that allows the download of payment transactions to a comma separated values (csv) file, a spreadsheet, or a text file.

25. A method as recited in claim 20, wherein said method comprise financial reports that further include information about payment transactions.

26. A method as recited in claim 1, wherein said method further provides the ability of site administrators to upload email addresses and contact information of group administrators to the site from a comma separated values (csv) file, a spreadsheet, a flat ascii file, a database or other file storage system.
